(19) United States
(12) Patent Application Publication
(10) Pub. No.: US 2007/0203010 A1
(43) Pub. Date: Aug. 30, 2007

(54) AUTOMATIC BALANCE ADJUSTABLE ROTOR FOR CENTRIFUGE APPARATUS

(76) Inventors: Do-Gyoon Kim, Daejeon (KR); Hak-Chul Kim, Gyeonggi-Do (KR); Heui-Geun Ryu, Seoul (KR)

Correspondence Address: IPLA P.A., 3580 WILSHIRE BLVD., 17TH FLOOR, LOS ANGELES, CA, 90010, US

(21) Appl. No.: 11/462,689

(22) Filed: Aug. 4, 2006

(30) Foreign Application Priority Data
Feb. 24, 2006 (KR) 10-2006-0018327

(51) Int. Cl. B04B 9/14

(52) U.S. Cl. 494/82; 494/20

(57) ABSTRACT

Provided is an automatic balance adjustable rotor for a centrifuge apparatus which enables to detect a weight unbalance between samples installed to buckets of the rotor, allows the rotor lever to move horizontally by the detection result, and distribute the remaining eccentric unbalance weight by a back lash during the rotation of the rotor. The rotor of the present invention comprises: a rotor lever (100) which ends are configured for supporting buckets in which samples are installed, wherein a block worm gear (104) is installed at the center of the top surface of the rotor lever; a rotor body (110) for supporting and allowing the rotor lever to horizontally move; a lever movement motor (180) installed in the rotor body; and a power transmission means (200) for transmitting a rotational force of the lever movement motor to the block worm gear, allowing the rotor lever to horizontally move.

### CROSS REFERENCE

Applicant claims foreign priority under Paris Convention and 35 U.S.C. §119 to a Korean Patent Application No. 10-2006-0018327, filed Feb. 24, 2006 with the Korean Intellectual Property Office.

### BACKGROUND OF THE INVENTION

1. Field of Invention

The present invention relates to an automatic balance adjustable rotor for a centrifuge apparatus, and more particularly, to an automatic balance adjustable rotor for a centrifuge apparatus which may detect a weight unbalance between samples installed to buckets to be mounted to the rotor before a centrifuge operation, allowing the rotor lever to be horizontally moved in an accurate manner depending on the detection result so that a dynamic balance may be maintained during the centrifuge operation, and distributing the remaining eccentric unbalance weight due to a back lash during the rotation of the rotor so that the durability of the rotor which is required for a high-speed rotation may be reliably assured.

2. Description of the Prior Art

The centrifuge apparatus is an apparatus in which a bucket with a sample embedded therein is installed to a rotor, allowing the rotor to be rotated with a high speed so that a high centrifugal acceleration may be assigned to the sample, and therefore, high density sample components are allowed to be positioned to an exterior layer in the radial direction while low density sample components are allowed to be positioned to an internal layer in the radial direction so that various components in the sample may be centrifuged.

A representative example of the automatic balance adjustable rotor for the centrifuge apparatus is disclosed to Korean Patent No. 470068, which was proposed by the applicant.

As shown in FIG. 1, the automatic balance adjustable rotor for the centrifuge apparatus uses a mechanism for moving a lever central body 636 horizontally according to a control algorithm in order to compensate the weight unbalance between samples which are installed to buckets to be mounted to both sides of a rotor lever 632. The lever movement mechanism used herein is configured to include a worm 662 axially coupled with a lever movement motor 652, a worm gear (not shown) engaged with the worm 662, a pinion 666 coaxially coupled with the worm gear, and the lever central body 636 having a rack 636a engaged with the pinion 666.

Further, a pressure sensor 690 for measuring the weights of the samples installed to the buckets (not shown) is provided under the rotor lever 632, and, in order to realize the automatic balance, a wiring layer 560 for receiving an electrical signal of the pressure sensor 690 and for transmitting the electrical signal to the lever movement motor 652 in accordance with the control algorithm is provided under the lever central body 636.

According to the conventional automatic adjustable rotor for the centrifuge apparatus as constructed above, the weights of the buckets installed to both ends of the rotor lever 632 may be measured to detect if the samples are unbalanced or not. In order to maintain the dynamic balance state between the samples installed to the buckets during the rotation of the rotor for centrifuge, the distance difference between each sample and the rotational axis of the rotor which is calculated from the weight difference between the samples may be controlled, allowing the centrifugal forces applied to the samples to be identical with each other. Since the detailed description has been described in the published prior art, the description thereof will be omitted.

However, the conventional automatic balance adjustable rotor for the centrifuge apparatus so configured above has a problem as described below.

That is, the power transmission mechanism of worm 662 and worm gear, and rack 636a and pinion 666 may be used as the means for controlling the movement of the lever central body 636 in itself in a radial direction to maintain the automatic balance. In this case, since the remaining eccentric unbalance weight is locally concentrated to one or two contact tooth faces between the worm 662 and the worm gear along the weight path due to the back lash of these gear portions during the rotation of the rotor, there is considerable weakness due to the stress concentration mechanism in view of the structural durability. Further, since the rotor is rotated with a high speed in this case, the conventional rotor has a disadvantage in that it is not suitable to the high-speed rotation.

### SUMMARY OF THE INVENTION

The present invention is conceived to solve the aforementioned problems in the prior art. Accordingly, an object of the present invention is to an automatic balance adjustable rotor for the centrifuge apparatus which may detect a weight unbalance between samples installed to buckets to be mounted to the rotor before a centrifuge operation, allowing the rotor lever to be horizontally moved in an accurate manner depending on the detection result so that a dynamic balance may be maintained during the centrifuge operation, and distributing the remaining eccentric unbalance weight due to a back lash during the rotation of the rotor so that the durability of the rotor which is required for the high-speed rotation may be reliably assured.

### ADVANTAGEOUS EFFECTS

According to an automatic balance adjustable rotor for a centrifuge apparatus in accordance with the present invention, the unbalance of the rotor's own centrifugal force, which may be generated due to the weight difference of respective samples to be installed thereto voluntarily, may be accurately compensated as the rotor lever 100 is horizontally moved through the block worm gear 104 provided in the rotor lever 100 and the power transmission means 200 for transmitting the rotational force of the lever movement motor 180 to the block worm gear 104, so that the excess vibration due to the unbalance of the centrifuge may be prevented during the centrifuge operation, thereby allowing the life-span of the rotor and the centrifuge apparatus of the present invention to be extended and protecting the samples from being damaged.

Since there is no need that the user directly measures the weight of the sample and there is no need that the user should load the samples by the required number thereof, the centrifuge may be exactly and promptly be performed by the user, allowing an advantage in that the operation time required for the centrifuge operation may be minimized and the operation efficiency may be improved.

Further, if the conventional power transmission mechanism such as the worm and the worm gear as well as the rack and the pinion is used as the power transmission means 200, there may be an disadvantage in view of the structural durability in that the remaining eccentric unbalance weight during the rotation of the rotor due to the back lash is concentrated to one or two contact tooth surface of the worm and the worm gear on the weight transmission path. Such disadvantage may be complemented in accordance with the present invention in that the power transmission means 200 configured to include the pulley 201 and 202, the belt, the worm 203 and the block worm gear 104 may be realized or the power transmission means 200 configured to include the first worm 220, the worm gear 221, the second worm 222 and the block worm gear 104 may be realized, so that the eccentric unbalance weight may be distributed appropriately on the weight path to a plurality of contact tooth faces of the worm 203 and 222 and the block worm gear 104, allowing the durability of the rotor in a stable manner. To this end, the present invention may be not only applied to the rotor in which the centrifuge operation is required at a middle or a low rotation, but also it may be effectively applied to the rotor in which the high-speed rotation is required.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a schematic cross-sectional view showing a conventional automatic adjustable rotor for a centrifuge apparatus;

FIG. 2 is a perspective view showing an exterior of an automatic balance adjustable rotor for the centrifuge apparatus in accordance with present invention;

FIG. 3 is an exploded perspective view showing an automatic balance adjustable rotor for the centrifuge apparatus in accordance with present invention;

FIG. 4 is a cross-sectional view taken by a line IV-IV;

FIG. 5 is an exploded perspective view showing another embodiment of an automatic balance adjustable rotor for the centrifuge apparatus in accordance with present invention;

FIG. 6 is a cross-sectional view of the automatic balance adjustable rotor for the centrifuge apparatus shown in FIG. 5; and

FIG. 7 is an electrical block configuration of the automatic balance adjustable rotor for the centrifuge apparatus in accordance with the present invention.

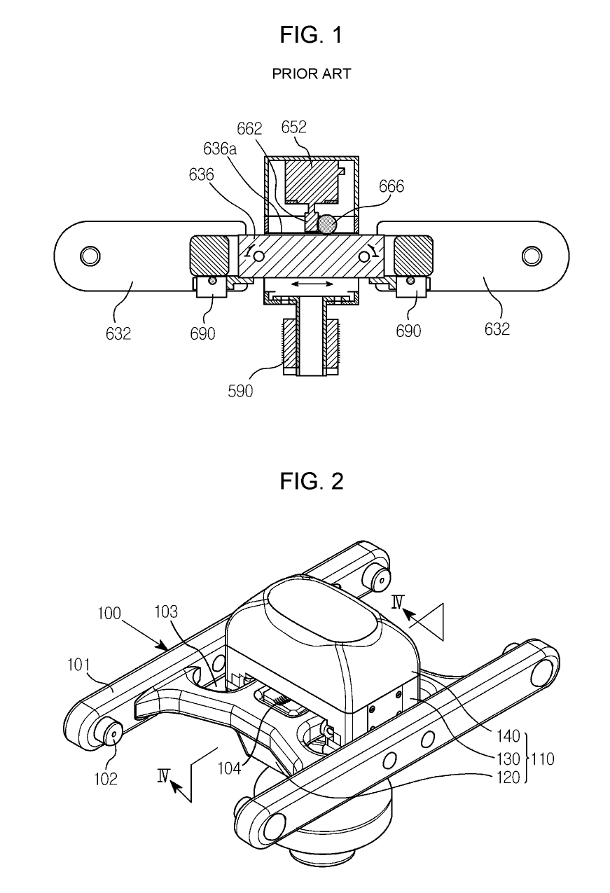

### DESCRIPTIONS FOR REFERENCE NUMERALS

100: rotor lever

104: block worm gear

110: rotor body

120: bottom housing

130: mediate housing

140: top cover

180: lever movement motor

200: power transmission means

201: drive pulley

202: follow pulley

203: worm

220: first worm

221: worm gear

222: second worm

### DETAILED DESCRIPTION OF THE PREFERRED EMBODIMENT

According to an aspect of the present invention for achieving the objects, there is provided an automatic balance adjustable rotor for a centrifuge apparatus, comprising a rotor lever, both ends of which are configured to be capable of supporting buckets in which samples are installed, wherein a block worm gear is installed in a lengthwise direction at a central portion of a top surface of the rotor lever; a rotor body for supporting the rotor lever, allowing the rotor lever to be horizontally moved in an accurate manner; a lever movement motor installed in the rotor body; and a power transmission means for transmitting a rotational force of the lever movement motor to the block worm gear, allowing the rotor lever to be horizontally moved.

In accordance with the present invention, the rotor body is configured to include: a bottom housing positioned to a lower portion of the rotor lever; a mediate housing coupled with a top portion of the rotor lever through both widthwise directional ends of the rotor lever to support the rotor lever together with the bottom housing, allowing the rotor lever to be horizontally moved; and a top cover coupled with a top portion of the mediate housing, allowing the lever movement motor to be embedded therein.

Further, the power transmission means is configured to include: a drive pulley axially coupled with the lever movement motor; and a worm rotatably supported by the rotor body while being tooth-coupled with the block worm gear, wherein a follow pulley connected to the drive pulley with a belt is coupled with one end of the worm. It is preferable that all teeth of the worm are engaged with the block worm gear.

Further, the power transmission means is configured to include: a first worm axially coupled with the lever movement motor; a worm gear rotatably supported by the rotor body and engaged with the first worm in a predetermined gear ratio; and a second worm coaxially coupled to the worm gear to be rotatably supported by the rotor body and tooth-coupled with the block worm gear. It is preferable that all teeth of the second worm are engaged with the block worm gear.

The features and advantages of the present invention will become apparent from the following description of preferred embodiments given in conjunction with the accompanying drawings. First of all, a term and a word used in the specification and claims should be understood to have a meaning and a concept to be matched to the technical spirit of the present invention based on the principle that any inventor may define the concept of the term appropriately in order to illustrate his/her own invention in a best mode.

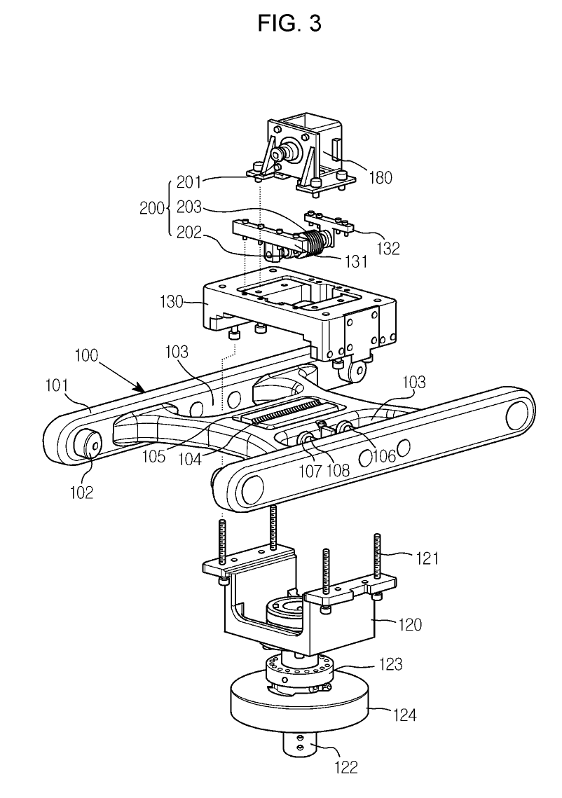

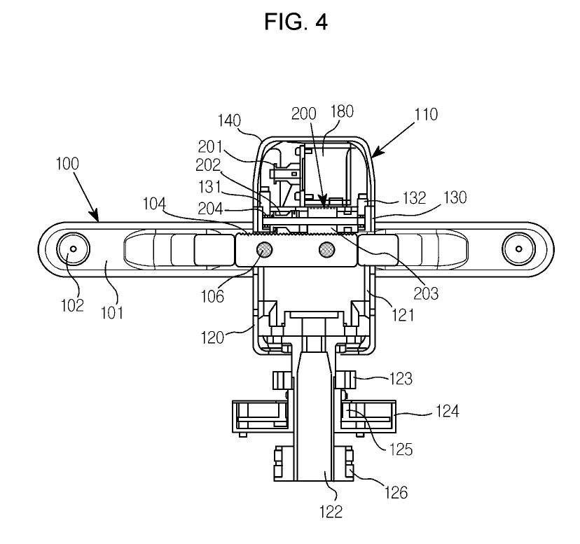

FIGS. 2 to 4 show an automatic balance adjustable rotor for a centrifuge apparatus in accordance with the present invention.

The automatic balance adjustable rotor for the centrifuge apparatus in accordance with the present invention is configured to include a rotor lever 100, a rotor body 110, a lever movement motor 180 and a power transmission means 200.

The rotor lever 100 includes two pairs of rotor arms 101 formed at both sides thereof. Bucket pins 102 are provided to an inside of each rotor arm 101 in order to be capable of setting up to support buckets (not shown) in which samples is enclosed.

Through-holes 103 which are penetrated upward and downward are formed at both sides (i.e., at both widthwise directional sides) around a central portion of the rotor lever 100, respectively, and a block worm gear 104 is provided to a top surface of the central portion of the rotor lever 100 in a lengthwise direction. The block worm gear 104 is inserted into coupling holes 105 formed at the central portion of the rotor lever 100 so that it may be fixed by means of lever pins 106 which are inserted from each through-hole 103 to each coupling hole 105. A bearing 107 and a roller 108 are mounted to both ends of each lever pin 106, respectively, so that the bearing 107 and the roller 108 may be rotated vertically and horizontally, respectively, and, therefore, the bearing 107 and the roller 108 are in contact with the rotor body 110 as described below so that the horizontal movement of the rotor lever 100 may be smoothly realized.

The rotor body 110 is configured to include a bottom housing 120, a mediate housing 130 and a top cover 140. The bottom housing 120 and the mediate housing 130 are arranged to lower and upper portions, respectively, so that the bottom housing 120 and the mediate housing 130 may be coupled with each other to support the rotor lever 100 in a horizontally movable manner. For example, housing fixing bolts 121 coupled to both upper ends of the bottom housing 120 are fastened through the through-holes 103 of the rotor lever 100 to both lower ends of the mediate housing 130, allowing the bottom housing 120 and the mediate housing 130 to be coupled with each other. At this time, it is preferable that the bearing 107 and the roller 108 are rotatably contacted with the top surface of the bottom housing 120.

The top cover 140 is coupled with the top portion of the mediate housing 130, and the lever movement motor 180 is embedded in the top cover 140.

Further, a motor axis coupling unit 122 for coupling a rotor driving motor 380 (see FIG. 7) for rotating the rotor of the present invention may be coupled with a lower end portion of the bottom housing 120. On the outside of the motor axis coupling unit 122, a sealing bushing 123 for the effective soundproof and insulation during the rotation of the rotor, a printed circuit board (PCB) housing 124 in which a PCB 125 is loaded to be in charge of the electric signal transmission between the lever movement motor 180 and a control unit 300, and a wiring layer 126 may be sequentially installed from upward to downward.

Meanwhile, the power transmission means 200 serves to transmit the power of the lever movement motor 180 to the block worm gear 104 of the rotor lever 100 in order to automatically compensate the weight unbalance of any material installed therein during the rotation of the rotor, allowing the rotor lever 100 to be horizontally moved. The power transmission means 200 is configured to include a drive pulley 201 axially coupled to the lever movement motor 180; and a worm 203 rotatably supported by the rotor body 110 while being tooth-coupled with the block worm gear 104, wherein a follow pulley 202 connected to the drive pulley 201 with a belt is coupled with one end of the worm 203. It is preferable that the drive pulley 201 is coupled with the axis which is drawn from one side of the lever movement motor 180, the worm 203 is arranged in parallel with the block worm gear 104, allowing the warm 203 and the block warm gear 104 to be engaged with each other, and all teeth of the worm 203 are engaged with the block worm gear 104.

The worm 203 may be ratotably supported to worm axis support frames 131 and 132 coupled with both sides of the mediate housing 130 by intervening bearings 204 in the worm axis support frames 131 and 132.

Accordingly, since the driving force of the worm 203 which is rotated according to the control of the lever movement motor 180 is unilaterally transmitted to the block worm gear 104, and the back lash from the block worm gear 104 to the worm 203 cannot be reversely performed, the eccentric unbalance weight of the rotor lever 100 can be solved. Further, from such construction, it is understood that the number of teeth which are engaged with each other to transmit the power is one or two in the power transmission means which includes the conventional worm and the conventional worm gear. However, in a general case that the tooth number of the block worm gear 104 is greater than that of worm 203, if the tooth-coupling structure between the worm 203 and the block worm gear 104 is applied in accordance with the present invention, the teeth of the block worm gear 104 corresponding to the number which is identical to the total teeth number of the worm 203 are engaged with the total teeth of the worm 203 to transmit the power, so that the power transmission efficiency may be high, the load may be distributed, and the total teeth number of the worm 203 may be also advantageously controlled depending on the required rotational number and the operational condition of the rotor.

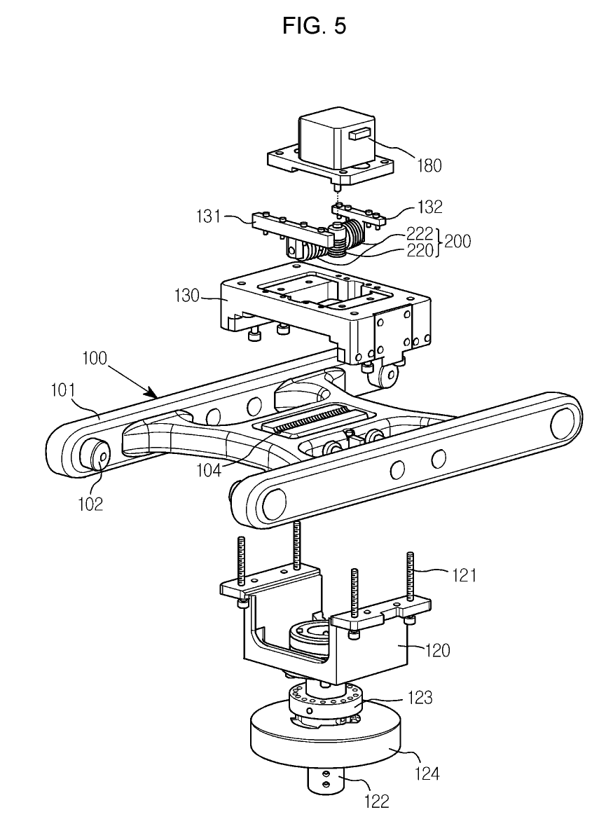

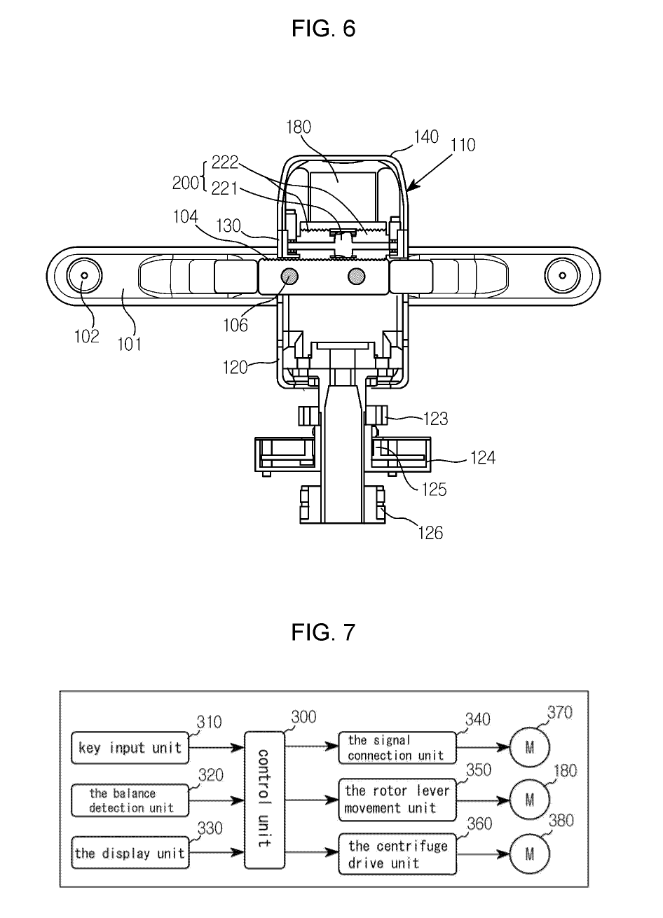

FIGS. 5 and 6 show another embodiment of the automatic balance adjustable rotor for the centrifuge apparatus, in which the power transmission means 200 is configured to include a first worm 220 axially coupled to the lever movement motor 180; a worm gear 221 rotatably supported to the mediate housing 130 of the rotor body 110 and engaged with the first worm 220 in a proper gear ratio; and a second worm 222 coaxially coupled with the worm gear 221 to be rotatably supported by the mediate housing 130 of the rotor body 110 and tooth-coupled with the block worm gear 104. The other components are similar to those as described in the previous embodiment.

Further, in the power transmission means 200 of the present embodiment of the present invention, it is preferable that the second worm 222 is arranged in parallel with the block worm gear 104, allowing all teeth of the second worm 222 to be engaged with the block worm gear 104, and the first worm 220 is coupled with the axis extruded to the downward of lever movement motor 180, allowing the first worm 220 to be perpendicularly engaged with the worm gear 221.

The power transmission means 200 of the present embodiment of the present invention supplements somewhat over the previous embodiment as described above, in which the automatic dual anti-reverse-rotation function between the first worm 220 and the worm gear 221 and between the second worm 222 and the block worm gear 104 may be dually performed. Accordingly, the automatic anti-reverse-rotation function of the power transmission means 200 may be more enhanced over the irregular vibration of the rotor which may be generated from the remaining eccentric unbalance weight due to the back lash of the gear unit during the rotation of the rotor, and the transmitted power may be preferably distributed in two steps. Further, in the present embodiment, the short life span due to the wear and tear of the belt to be used therein may be advantageously largely enhanced.

Meanwhile, FIG. 7 shows an electrical block diagram for the whole operation of the centrifuge apparatus in which the automatic balance adjustable rotor is prepared in accordance with the present invention.

The electrical configuration for the whole operation of the centrifuge apparatus in which the automatic balance adjustable rotor is prepared in accordance with the present invention includes a key input unit 310 for selecting and inputting respective functions which are provided to the centrifuge apparatus in which the automatic balance adjustable rotor is prepared; and a weight measuring device (not shown) mounted within the centrifuge apparatus. Further, the electrical configuration may further include a balance detection unit 320 for detecting the weight balance state of the samples to be loaded through buckets (not shown) mounted to the rotor arm 101; a display unit 330 for displaying respective operation states such as the present setup conditions to a display panel; the control unit 300 for controlling the overall operation of the centrifuge apparatus; a rotor lever movement unit 350 for driving the lever movement motor 180, allowing the rotor lever 100 to be precisely and horizontally moved from an initial balance position detected through a position sensor (not shown) mounted in the mediate housing 130 along a concave groove between the mediate housing 130 and the bottom housing 120; a signal connection unit 340 for driving each wiring layer connection motor 370 to connect a wiring connection panel (not shown) to the wiring layer 126 so that an electrical system may be installed to transmit a control command to the rotor lever movement unit 350 depending on a detection signal of the balance detection unit 320; and a centrifuge drive unit 360 for driving the rotor driving motor 380 to rotate the automatic balance adjustable rotor of the present invention to which buckets (not shown) are mounted.

From the construction of the electrical signal system as described above, the lever movement motor 180 may be realized with a stepping motor which is capable of controlling the rotation angle exactly or with a servo motor. In the control unit 300, a relationship of a movement distance from an initial balance position in the concave groove formed between the mediate housing 130 and the bottom housing 120 with respect to the rotor lever 100 depending on the rotation angle of the lever movement motor 180, a calculation equation (Eq. 1) for the movement distance (as described below) of the rotor lever 100 depending on the sample weight difference to realize the centrifugal force balance, etc. may be installed.

Hereinafter, the operation sequence and the principle of the centrifuge apparatus in which the automatic balance adjustable rotor is installed in accordance with the present invention so constructed will be described in detail.

First, both side buckets (not shown) are mounted to the bucket pins 102 of the rotor arm 101, and adapters (not shown) with samples installed therein are mounted to the buckets, respectively. At this time, if a command which is matched to the centrifuge conditions depending on each sample type is inputted through the key input unit 310, the control unit 300 analyzes the received command and sends another command for the analyzed result to the signal connection unit 340.

The signal connection unit 340 drives the wiring layer connection motor 370 to connect the wiring connection panel (not shown) to the wiring layer 126, and transmits the control signal of the control unit 300 as the command through the PCB 125 to the rotor lever movement unit 350.

Then, the rotor lever movement unit 350 drives the lever movement motor 180 depending on the transmitted control signal in an accurate manner, allowing the rotor lever 100 to be moved to a dynamic balance position of the rotor determined by detecting a current horizontal position recurrently with a position sensor mounted in the mediate housing 130 so that the rotor lever 100 may be moved toward the dynamic balance position of the rotor.

After the control unit 300 allows the rotor lever 100 to be horizontally moved to the dynamic balance position of the rotor in an accurate manner, the control unit 300 sends a command to the signal connection unit 340 again, allowing the wiring connection panel (not shown) to be detached from the wiring layer 126.

After the initial dynamic balance state of the rotor is established, the control unit 300 sends a command to the balance detection unit 320, allowing a weight detection sensor (not shown) to be moved upward from the bottom of the buckets (not shown) by means of its own weight detection apparatus so that the weight of the sample loaded to each bucket (not shown) may be indirectly detected with the constraint in the bucket pin 102 released.

Then, the control unit 300 receives a signal corresponding to the weights of the samples which are detected through the balance detection unit 320 and calculates in an accurate manner the horizontal movement distance of the rotor lever 100 for compensating the unbalance of the samples due to the weights of the samples.

Then, the control unit 300 sends a command to the signal connection unit 340 to drive the wiring layer connection motor 370, allowing the wiring connection panel (not shown) to be connected to the wiring layer 126.

The control unit 300 controls the rotation angle of the lever movement motor 180 corresponding to the horizontal movement distance of the rotor lever 100 calculated through the signal connection unit 340 connected thereto, allowing the rotational force of the lever movement motor 180 through the power transmission means 200 to the block worm gear 104 so that the rotor lever 100 may be moved in an accurate manner by the calculated distance along the concave groove between the mediate housing 130 and the bottom housing 120.

Then, the control unit 300 sends a command to the signal connection unit 340 to drive the wiring layer connection motor 370, allowing the wiring connection panel to be detached from the wiring layer 126.

At this state, the control unit 300 sends a command to the centrifuge drive unit 360 to drive the rotor driving motor 380, allowing the centrifuge operation to be performed with the whole rotor maintained in a dynamic balance.

Meanwhile, the display unit 330 allows the display panel to be displayed with the current setup state and the operational state when the centrifuge process is performed.

In the operational sequence and the principle of the centrifuge apparatus in which the automatic balance adjustable rotor in accordance with the present invention is installed, the control unit 300 may calculate the weight difference between the samples in the respective buckets (not shown) detected through the weight detection apparatus through the process described below, and the horizontal movement distance of the rotor lever 100 for compensating the centrifugal force unbalance between the samples by using the dynamic balance relationship for the centrifugal force of the rotor as follows:

M₁R₁Ω²=MᵣRᵣQ² Eq. 1

wherein, with reference to the rotational axis of the horizontal rotor, M₁ and Mᵣ represent the total weights including the left and the right rotor levers 100, their corresponding buckets and their corresponding adapters in which the samples are installed, respectively, wherein the total weight may be actually measured by adding the actually measured mean masses of the base rotor levers 100, the buckets and the adapters to the indirectly measured masses of the left and the right samples which are measured during each centrifuge in the weight measuring apparatus of the balance detection unit 320. Further, R₁ and Rᵣ represent the distances from the center of the rotational axis of the rotor to left and right total mass portions M₁ and Mᵣ, respectively, wherein R₁ and Rᵣ may be induced from the distances of the centers of mass of the respective constitutional components during the horizontal movement of each rotor levers 100. Further, Ω represents the rotational velocity of the rotor.

In conclusion, Eq. 1 represents that, with reference to the rotational axis of the horizontal rotor, the total centrifugal force of the left mass portion and the total centrifugal force of the right mass portion maintain in a dynamic balance with each other during the rotation, allowing the resultant rotational force to be 0. That is, the horizontal movement distance of the rotor lever 100 required to maintain the centrifugal force dynamic balance may be induced through the centrifugal force dynamic balance relationship described above when the rotor is rotated due to the weight difference between the left and the right samples.

Meanwhile, in the signal connection unit 340, the lever movement motor 180 positioned in the rotor, and the wiring layer 126 and the PCB 125 connected to an electrical circuit unit of the position sensor (not shown) are mounted around the axis of the rotor driving motor 380 so that the wiring layer 126 may be connected to or detached from the rotor arm 101 with the electrical wiring within and outside the wiring connection panel (not shown) untwisted when the axis of the rotor driving motor 380 is rotated by an appropriate angle.

Further, the rotor lever movement unit 350 serves as the lever movement control means as described above.

What is claimed is:

1. An automatic balance adjustable rotor for a centrifuge apparatus, comprising:
a rotor lever (100), both ends of which are configured to be capable of supporting buckets in which samples are installed, wherein a block worm gear (104) is installed in a lengthwise direction at a central portion of a top surface of the rotor lever (100);
a rotor body (110) for supporting the rotor lever, allowing the rotor lever to be horizontally moved in an accurate manner;
a lever movement motor (180) installed in the rotor body; and
a power transmission means (200) for transmitting a rotational force of the lever movement motor to the block worm gear, allowing the rotor lever to be horizontally moved.

2. The rotor as claimed in claim 1, wherein the rotor body (110) is configured to include:
a bottom housing (120) positioned to a lower portion of the rotor lever (100);
a mediate housing (130) coupled with a top portion of the rotor lever through both widthwise directional ends of the rotor lever to support the rotor lever together with the bottom housing, allowing the rotor lever to be horizontally moved; and
a top cover (140) coupled with a top portion of the mediate housing, allowing the lever movement motor (180) to be embedded therein.

3. The rotor as claimed in claim 1, wherein the power transmission means (200) is configured to include:
a drive pulley (201) axially coupled with the lever movement motor (180); and
a worm (203) rotatably supported by the rotor body (110) while being tooth-coupled with the block worm gear (104), wherein a follow pulley (202) connected to the drive pulley (201) with a belt is coupled with one end of the worm (203).

4. The rotor as claimed in claim 3, wherein all teeth of the worm (203) are engaged with the block worm gear (104).

5. The rotor as claimed in claim 1, wherein the power transmission means (200) is configured to include:
a first worm (220) axially coupled with the lever movement motor (180);
a worm gear (221) rotatably supported by the rotor body (110) and engaged with the first worm (220) in a predetermined gear ratio; and
a second worm (222) coaxially coupled to the worm gear (221) to be rotatably supported by the rotor body and tooth-coupled with the block worm gear (104).

6. The rotor as claimed in claim 5, wherein all teeth of the second worm (222) are engaged with the block worm gear (104).
